(19) United States
(12) Patent Application Publication
(10) Pub. No.: US 2026/0245848 A1
(43) Pub. Date: Aug. 20, 2026

(54) MASS SPECTROMETER AND CALIBRATION METHOD FOR MASS SPECTROMETER

(71) Applicant: HITACHI HIGH-TECH CORPORATION, Tokyo (JP)

(72) Inventors: Tsugunao TOMA, Tokyo (JP); Riku TAMURA, Tokyo (JP); Masaki YOSHIE, Tokyo (JP); Hiroyuki YASUDA, Tokyo (JP); Masuyuki SUGIYAMA, Tokyo (JP); Yuichiro HASHIMOTO, Tokyo (JP)

(21) Appl. No.: 19/164,653

(22) PCT Filed: May 23, 2024
(86) PCT No.: PCT/JP2024/019052

§ 371 Date: Sep. 12, 2025

(30) Foreign Application Priority Data
Jun. 30, 2023 (JP) 2023-108640

(51) Int. Cl. H01J 49/00

(52) U.S. Cl. CPC H01J 49/0009; H01J 49/0031

(57) ABSTRACT

Provided are a mass spectrometer and a calibration method for a mass spectrometer capable of performing calibration more easily than one in the related art. A mass spectrometer 100 according to the present embodiment described above includes: an ion source 101 configured to ionize a sample; a detection unit 105 including a photomultiplier tube 105a and configured to analyze a mass of the sample ionized by the ion source 101; a vacuum chamber 102 configured to allow the ion source 101 to communicate with the detection unit 105; a vacuum gauge 106 configured to measure a vacuum degree inside the vacuum chamber 102; and a data analysis unit 112 and an analysis control unit 113 configured to calibrate setting of the photomultiplier tube 105a using electrons emitted from the vacuum gauge 106.

### TECHNICAL FIELD

The present invention relates to a mass spectrometer and a calibration method for a mass spectrometer.

### BACKGROUND ART

PTL 1 describes a mass spectrometer that includes a gas injection port adapted to supply a sample gas to be ionized to an ionization region of the mass spectrometer, a calibration unit adapted to supply a calibration gas to be ionized to the ionization region, and an ionization unit adapted to ionize the sample gas and/or the calibration gas in the ionization region, in which the calibration unit includes at least one evaporation source that generates the calibration gas by evaporating a raw material.

### CITATION LIST

### Patent Literature

PTL 1: JP2022-553543A

### SUMMARY OF INVENTION

### Technical Problem

The mass spectrometer includes an ion source that ionizes a compound in a sample, a mass spectrometry unit such as a mass filter that separates ions derived from the compound according to a mass-to-charge ratio (m/z), and a detector that detects the separated ions.

PTL 1 describes that in the mass spectrometer provided with a vacuum chamber that allows the ion source to communicate with the mass spectrometry unit, an ionization type vacuum gauge that measures a vacuum degree inside the vacuum chamber is provided, and the vacuum gauge is operated at a timing when measurement is not being performed in the mass spectrometry unit to calibrate the detector of the mass spectrometry unit using the calibration gas.

Thus, it is necessary to ionize and introduce the sample in order to calibrate the detector of the mass spectrometer. However, since it is necessary to ionize the sample when the detector is calibrated, a technique capable of performing calibration more efficiently has been awaited.

The invention provides a mass spectrometer and a calibration method for a mass spectrometer that are capable of performing calibration more easily as compared with the related art.

### Solution to Problem

The invention includes a plurality of means for solving the above problems, and an example thereof includes: an ion source configured to ionize a sample; a mass spectrometry unit including a photomultiplier tube and configured to analyze a mass of the sample ionized by the ion source; a vacuum chamber configured to allow the ion source to communicate with the mass spectrometry unit; a vacuum gauge configured to measure vacuum degree inside the vacuum chamber; and a calibration unit configured to calibrate setting of the photomultiplier tube using electrons emitted from the vacuum gauge.

### Advantageous Effects of Invention

According to the invention, it is possible to perform calibration more easily as compared with the related art. Problems, configurations, and effects other than those described above will be clarified by the following description of an embodiment.

### BRIEF DESCRIPTION OF DRAWINGS

FIG. 1 is a diagram showing an overall configuration of a mass spectrometer.

FIG. 2 is a flowchart of voltage adjustment of a photomultiplier tube.

FIG. 3 is a sequence diagram of a voltage adjustment set of the photomultiplier tube.

FIG. 4 is a sequence diagram of voltage adjustment of the photomultiplier tube.

FIG. 5 is a diagram showing an example of display of a software GUI screen for voltage adjustment of the photomultiplier tube.

### DESCRIPTION OF EMBODIMENTS

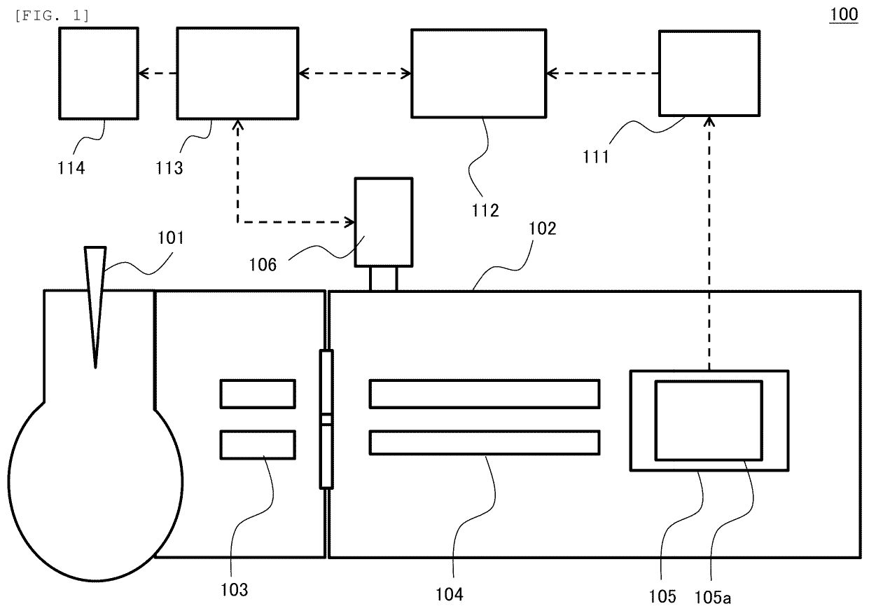

Embodiments of a mass spectrometer and a calibration method for a mass spectrometer according to the invention will be described with reference to FIGS. 1 to 5. the drawings used in the present specification, the same or corresponding components are denoted by the same or similar reference signs, and repeated descriptions of these components may be omitted.

First, an overall configuration of a mass spectrometer will be described with reference to FIG. 1. FIG. 1 is a diagram showing an overall configuration of the mass spectrometer.

A mass spectrometer 100 shown in FIG. 1 includes an ion source 101, a vacuum chamber 102 having an ion transport section 103, a mass separation unit 104, and a detection unit 105, a vacuum gauge 106, an A/D conversion unit 111, a data analysis unit 112, an analysis control unit 113, a display device 114, and the like.

The ion source 101 is a portion that ionizes a sample.

Inside of the vacuum chamber 102 is evacuated by a pump to transport the sample ionized by the ion source 101 to the detection unit 105, and the ion transport section 103, the mass separation unit 104, the detection unit 105, and the vacuum gauge 106 are disposed inside the vacuum chamber 102.

The ion transport section 103 is a portion that transports ions ionized by the ion source 101 and introduced into the vacuum chamber 102 toward the mass separation unit 104 or the detection unit 105 on a subsequent stage side.

The mass separation unit 104 is a device such as a mass filter that separates a compound in the ionized sample according to a mass-to-charge ratio (m/z).

The detection unit 105 is a portion that analyzes a mass of the sample by detecting ions separated into only a predetermined mass in the mass separation unit 104, and includes conversion dynodes (CD1, CD2), a scintillator, a photomultiplier tube 105a, and the like.

The vacuum gauge 106 is an ionization type vacuum gauge for measuring a vacuum degree inside the vacuum chamber 102, and examples thereof include a cold cathode ionization vacuum gauge (cold cathode gauge).

The analysis control unit 113 is a portion that is electrically connected to each mechanism in the mass spectrometer 100 and controls operations of these mechanisms, and in the present embodiment, calibrates setting of the photomultiplier tube 105a using electrons emitted from the vacuum gauge 106.

The analysis control unit 113 may be implemented by a computer including, for example, the display device 114 implemented by a liquid crystal display or the like, a memory implemented by a hard disk memory or an external memory, the A/D conversion unit 111 that converts a detection signal from analog to digital, an interface, an input device such as a keyboard for inputting an operation command or the like, and the data analysis unit 112, and may be implemented by one computer or may be implemented by separate computers, which is not particularly limited.

The data analysis unit 112 sends a command to the analysis control unit 113 and the like to control an operation of each mechanism. Data (photometric value) after A/D conversion obtained from the detection unit 105 via the A/D conversion unit 111 is input into the data analysis unit 112. The data analysis unit 112 performs arithmetic processing using the input data (photometric value). That is, the data analysis unit 112 can control each mechanism of the detection unit 105 via the analysis control unit 113, and can perform the arithmetic processing on the data.

An operation of each device is controlled by the analysis control unit 113 based on various programs recorded in a storage device. Operation control processing executed by the analysis control unit 113 may be integrated into one program, may be divided into a plurality of separate programs, or may be a combination thereof. A part or all of the programs may be implemented by dedicated hardware or may be modularized.

The display device 114 is a user interface such as a touch panel display, and outputs information to a user and receives various inputs from the user. In the present embodiment, the display device 114 displays a screen for setting a condition at the time of the calibration. Details thereof will be described below.

A drive voltage (hereinafter, referred to as a PMT voltage) of the photomultiplier tube 105a mounted on the detection unit 105 and an offset voltage (hereinafter, referred to as a base voltage) of a signal input into the A/D conversion unit 111 can be adjusted by a setting change from the A/D conversion unit 111 of the detection unit 105.

Since the mass spectrometer 100 and the photomultiplier tube 105a therein have different optimum base voltages and optimum PMT voltages, these voltages need to be optimized during setup after assembly of the mass spectrometer 100 and replacement of new components. Therefore, parameters of the A/D conversion unit 111 are mainly adjusted when the mass spectrometer 100 is assembled. In addition, when a trouble occurs during actual use, for example, the parameters of the A/D conversion unit 111 also need to be adjusted after replacement of components due to a failure in the A/D conversion unit 111 or the photomultiplier tube 105a.

In the mass spectrometer 100, the PMT voltage is adjusted by introducing a sample mainly including positive ions in the related art, but it takes time and effort to introduce the sample. Therefore, in the present embodiment, it is conceived that the PMT voltage, which is adjusted using ions in the related art, is adjusted using electrons.

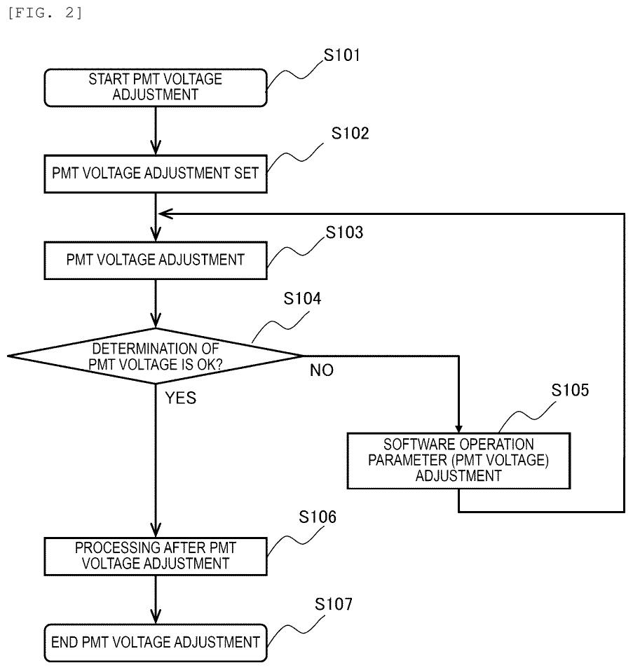

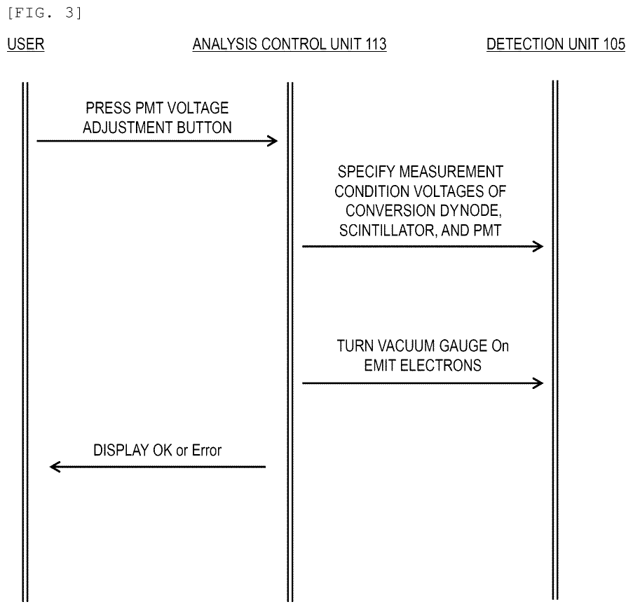

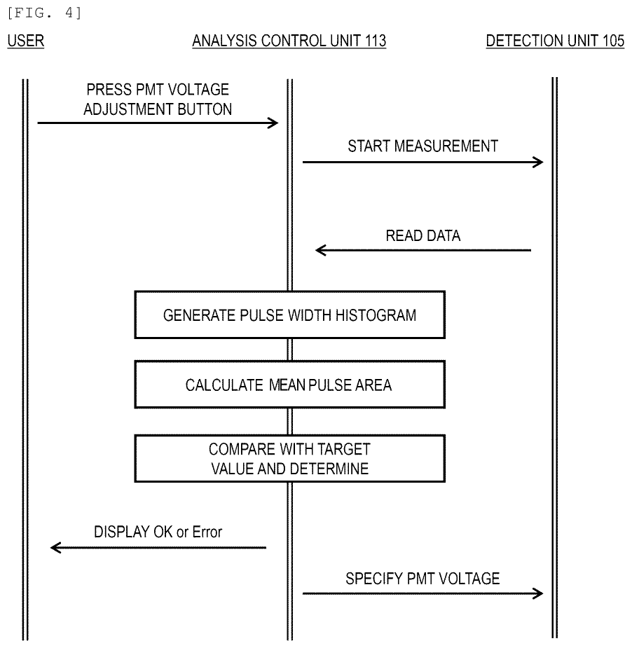

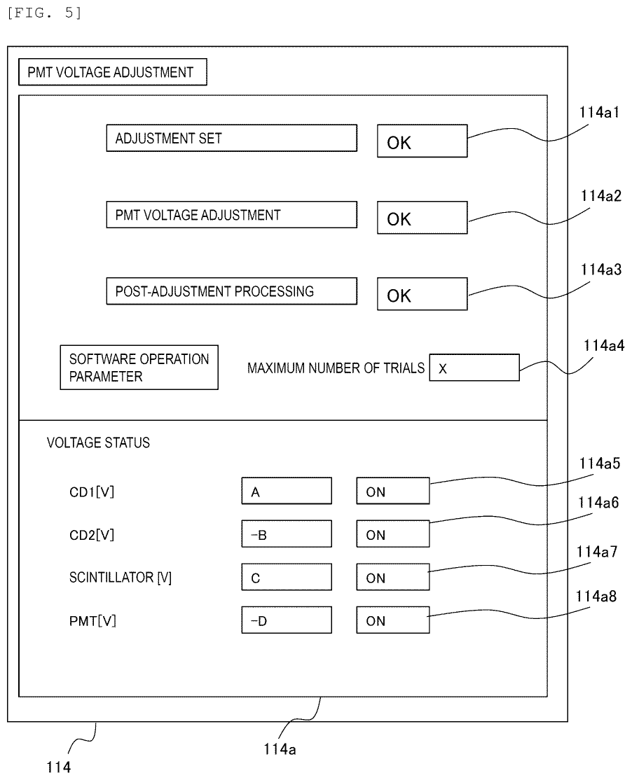

Next, an example of a flow of PMT voltage adjustment and operations of the mass spectrometer 100 will be described with reference to FIGS. 2 to 5. FIG. 2 shows a flowchart of the PMT voltage adjustment. FIG. 3 is a sequence diagram of a voltage adjustment set, FIG. 4 is a sequence diagram of voltage adjustment, and FIG. 5 is a diagram showing an example of display of a software GUI screen for the voltage adjustment.

First, a flow of preparation will be described with reference to FIG. 2. In the present embodiment, the data analysis unit 112 and the analysis control unit 113 perform calibration at a timing when analysis is not performed by the detection unit 105, but a timing of voltage adjustment is not limited to this timing.

First, when PMT voltage adjustment processing is started (S101), the analysis control unit 113 executes PMT voltage adjustment set (S102). The PMT voltage adjustment set is an operation before the PMT voltage adjustment, and is an operation of turning on various power supplies. For example, the PMT voltage adjustment set can be executed when it is recognized that a voltage adjustment set button 114a1 in a PMT voltage adjustment setting screen 114a displayed on the display device 114 as shown in FIG. 5 is selected and pressed by the user.

Next, the analysis control unit 113 performs PMT voltage adjustment (S103). For example, the PMT voltage adjustment can be executed when it is recognized that a PMT voltage adjustment button 114a2 in the PMT voltage adjustment setting screen 114a displayed on the display device 114 as shown in FIG. 5 is selected and pressed by the user.

At this time, in the present embodiment, since calibration is preferably performed by the electrons emitted from the vacuum gauge 106, it is desirable that the data analysis unit 112 and the analysis control unit 113 set setting of the detection unit 105 at a time of calibration to setting for measurement of negative ions.

Specifically, when the PMT voltage adjustment button 114a2 is pressed, the analysis control unit 113 specifies the conversion dynodes (CD1, CD2), the scintillator, and the PMT voltage for the detection unit 105 in an order of a time chart shown in FIG. 3.

For example, various parameters of adjustment software include “target value”, “allowable error (an allowable value)”, “Acoff (a step value of software adjustment)”, and “maximum number of trials (an upper limit value of repetition)” as described below.

As shown in FIG. 3, when the PMT voltage adjustment button 114a2 is pressed by the user, the analysis control unit 113 sets measurement condition voltages of the conversion dynodes, the scintillator, and the photomultiplier tube 105a to specified voltages and turns on each electrode so that the electrons are introduced into the detection unit 105. Next, the vacuum gauge 106 is turned on, and emission of the electrons is started.

Accordingly, as shown in FIG. 4, the analysis control unit 113 instructs the detection unit 105 to start measurement.

After reading software operation parameters of screen setting sent from the analysis control unit 113, the detection unit 105 repeats operations of a measurement processing flow, mean area value calculation, and target value comparison until either a setting parameter falls within a target value±an allowable error, or the number of repetitions=the maximum number of trials is reached.

The emitted electrons are detected as a count number (analog data) by the photomultiplier tube 105a via the conversion dynodes (CD1, CD2) and the scintillator according to parameter setting when the negative ions are detected in the detection unit 105. The detected data is converted from analog data to digital data by the A/D conversion unit 111 and then read into the data analysis unit 112 to generate a pulse width histogram, obtain an mean pulse area, perform a comparison with the target value, and perform a determination.

Here, the mean area value can be calculated using the following formula (1).

Mean value of ion amount gram=Σ(frequency×pulse area)/pulse number (1)

A mean value of the obtained ion amount gram is compared with the target value. In the comparison with the target value, if a calculation result obtained by the mean value calculation satisfies the target value±the allowable error (target value−allowable error≤mean value≤target value +allowable error), the repetitive operation is stopped, and “OK” is displayed in the PMT voltage adjustment setting screen 114a.

On the other hand, if the target value±the allowable error (target value−allowable error≤mean value≤target value+allowable error) is not satisfied even if the maximum number of trials set by a software operation parameter maximum number of trials setting button 114a4 is reached, the repetitive operation is stopped, and “error” is displayed in the PMT voltage adjustment setting screen 114a.

Next, as shown in FIGS. 2 to 4, the analysis control unit 113 requests the user to determine whether the determination of the PMT voltage has no problem (S104). For example, the analysis control unit 113 can adopt a form in which a measurement result and/or a determination result are displayed on the display device 114 as shown in FIG. 5 to request a determination from the user.

For example, when the repetitive operation ends under the above condition, a result of a pass or fail determination is output to the display device 114. The following is a classification of the determination result.

“OK”: A post-adjustment processing button 114a3 is enabled, the PMT voltage after adjustment is displayed on the display device 114, the PMT voltage in a voltage status frame in a PMT voltage button 114a8 in FIG. 5 is updated, and the analysis control unit 113 specifies the PMT voltage for the detection unit 105 (S106 to be described later).

“Error”: The post-adjustment processing button 114a3 is kept inoperable, and the user is notified of “please perform PMT voltage adjustment again” (S105 to be described later).

When it is determined in S104 that there is a problem, the process proceeds to S105, and the analysis control unit 113 performs adjustment based on the software operation parameter (PMT voltage) input by the user (S105).

For example, the adjustment can be performed by changing setting values of conversion dynode (CD1, CD2) voltages, a scintillator voltage, and the PMT voltage in a CD1 voltage button 114a5, a CD2 voltage button 114a6, a scintillator voltage button 114a7, and the PMT voltage button 114a8 in the PMT voltage adjustment setting screen 114a displayed on the display device 114 as shown in FIG. 5, and by changing the setting values through input. Thereafter, the process returns to step S103.

On the other hand, when it is determined in S104 that there is no problem, the process proceeds to S106, and the analysis control unit 113 executes processing after the PMT voltage adjustment (S106).

For example, the processing can be executed when it is recognized that the post-adjustment processing button 114a3 in the PMT voltage adjustment setting screen 114a displayed on the display device 114 as shown in FIG. 5 is selected and pressed by the user.

Here, it is desirable that the analysis control unit 113 disables the post-adjustment processing button 114a3 except for a state where the voltage adjustment set button 114a1 and the PMT voltage adjustment button 114a2 are “OK”, that is, both operations of the PMT voltage adjustment set and the PMT voltage adjustment are “OK”.

Thereafter, the analysis control unit 113 ends the PMT voltage adjustment (S107).

Next, effects of the present embodiment will be described.

The mass spectrometer 100 described above includes: the ion source 101 configured to ionize a sample; the detection unit 105 including the photomultiplier tube 105a and configured to analyze a mass of the sample ionized by the ion source 101; the vacuum chamber 102 configured to allow the ion source 101 to communicate with the detection unit 105; the vacuum gauge 106 configured to measure a vacuum degree inside the vacuum chamber 102; and the data analysis unit 112 and the analysis control unit 113 configured to calibrate setting of the photomultiplier tube 105a using the electrons emitted from the vacuum gauge 106.

Therefore, since the vacuum gauge 106 originally provided in the mass spectrometer 100 can be used, calibration work can be performed without separately introducing the sample, and thus the calibration can be easily performed as compared with the related art.

In addition, since the vacuum gauge 106 is of an ionization type, stable electrons are reliably and stably emitted, and thus the calibration work may be performed more smoothly.

Further, by performing the calibration at the timing when analysis is not being performed by the detection unit 105, the data analysis unit 112 and the analysis control unit 113 can reliably perform the calibration work without being inhibited by other work.

In addition, the data analysis unit 112 and the analysis control unit 113 may set setting of the detection unit 105 at a time of the calibration to setting for measurement of negative ions to be capable of utilizing related-art settings, and thus design and the like become easy.

Further, the display device 114 configured to display a screen for setting a condition at the time of the calibration is further provided, so that the user can easily execute and grasp a change in the setting condition, a status of calibration, and the like.

### Others

The invention is not limited to the embodiment described above, and various modifications and applications are possible. The embodiment described above is described in detail for easy understanding of the invention, and is not necessarily limited to those having all the configurations described above.

### REFERENCE SIGNS LIST

100: mass spectrometer
101: ion source
102: vacuum chamber
103: Ion transport section
104: mass separation unit
105: detection unit (mass spectrometry unit)
105a: photomultiplier tube
106: vacuum gauge
111: A/D conversion unit
112: data analysis unit (calibration unit)
113: analysis control unit (calibration unit)
114: display device
114a: PMT voltage adjustment setting screen
114a1: voltage adjustment set button
114a2: PMT voltage adjustment button
114a3: post-adjustment processing button
114a4: software operation parameter maximum number of trials setting button
114a5: CD1 voltage button
114a6: CD2 voltage button
114a7: scintillator voltage button
114a8: PMT voltage button

1. A mass spectrometer comprising:
an ion source configured to ionize a sample;
a mass spectrometry unit including a photomultiplier tube and configured to analyze a mass of the sample ionized by the ion source;
a vacuum chamber configured to allow the ion source to communicate with the mass spectrometry unit;
a vacuum gauge configured to measure a vacuum degree inside the vacuum chamber; and
a calibration unit configured to calibrate setting of the photomultiplier tube using electrons emitted from the vacuum gauge.

2. The mass spectrometer according to claim 1, wherein
the vacuum gauge is of an ionization type.

3. The mass spectrometer according to claim 1, wherein
the calibration unit performs calibration at a timing when analysis is not performed in the mass spectrometry unit.

4. The mass spectrometer according to claim 1, wherein
the calibration unit sets setting of the mass spectrometry unit at a time of the calibration to setting for measurement of negative ions.

5. The mass spectrometer according to claim 1, further comprising:
a display device configured to display a screen for setting a condition at a time of the calibration.

6. A calibration method for a mass spectrometer,
the mass spectrometer including
an ion source configured to ionize a sample,
a mass spectrometry unit including a photomultiplier tube and configured to analyze a mass of the sample ionized by the ion source,
a vacuum chamber configured to allow the ion source to communicate with the mass spectrometry unit, and
a vacuum gauge configured to measure a vacuum degree inside the vacuum chamber,
the calibration method for a mass spectrometer comprising:
calibrating setting of the photomultiplier tube using electrons emitted from the vacuum gauge.
